(19) United States
(12) Patent Application Publication
(10) Pub. No.: US 2008/0238603 A1
(43) Pub. Date: Oct. 2, 2008

(54) METHODS AND APPARATUS FOR ATTACHING A THERMAL SWITCH TO A TUBE

(75) Inventors: Byron G. Scott, Arlington, WA (US); George D. Davis, Bellevue, WA (US)

Correspondence Address: HONEYWELL INTERNATIONAL INC.;PATENT SERVICES AB-2B, 101 COLUMBIA ROAD, P.O. BOX 2245, MORRISTOWN, NJ, 07962-2245, US

(73) Assignee: HONEYWELL INTERNATIONAL INC., Morristown, NJ (US)

(21) Appl. No.: 11/691,184

(22) Filed: Mar. 26, 2007

(51) Int. Cl. H01H 61/00; H01H 37/04; H01H 37/52

(52) U.S. Cl. 337/380

(57) ABSTRACT

A device for attaching a thermal switch to a tube. The device includes a base having first and second sides and a thermal switch cavity located between opposing ends of the base on the first side. The cavity is configured to receive a thermal switch. Two straps attach the device to a tube at the opposing ends. The base, ends, and cavity are formed of aluminum coated with a low electrical resistance, chemical conversion coating. The second side is formed to receive a tube, such as a fuel line, of a predefined radius. Each of the ends includes at least one groove for receiving one of the straps. The straps are a low outgassing material.

### BACKGROUND OF THE INVENTION

Mounting thermal switches on tubes for purposes of temperature monitoring and thermal control such as those in satellites or other devices has historically been a challenge. One present method for mounting thermal switches to tubes uses a corrosion resistant (CRES) radius matching mounting adaptor that is attached to the tube using thin sheet metal straps. Although this method and other methods that use screws with backing plates are effective for holding the thermal switch to the tube, the CRES is typically quite heavy and is not the most effective thermal conductor. Also, the sheet metal straps at times do not hold the sensor as securely as some applications require. Another concern in space applications is that fastener hardware may loosen or dislodge thereby causing problems.

Therefore, there exists a need for a light weight, more easily attachable, and more thermally conductive device for attaching thermal switches to tubes. Improved thermal conductivity of the attachment device would increase the effectiveness and accuracy of the thermal switch.

### SUMMARY OF THE INVENTION

The present invention provides a device for attaching a thermal switch to a tube. The device includes a base having first and second sides and a thermal switch cavity located between opposing ends of the base on the first side. The cavity is configured to receive a thermal switch. Two straps attach the device to a tube at the opposing ends. The second side is formed to receive a tube, such as a fuel line, of a predefined radius.

In one aspect of the invention, each of the ends includes at least one groove for receiving one of the straps. The straps are a low outgassing material.

In another aspect of the invention, the base, ends, and cavity include aluminum with a low electrical resistance, chemical conversion coating.

In still another aspect of the invention, two devices are attached on opposing sides of the tube using the two straps.

### BRIEF DESCRIPTION OF THE DRAWINGS

Preferred and alternative embodiments of the present invention are described in detail below with reference to the following drawings:

FIG. 1 is a perspective view of a thermal switch mounting device formed in accordance with an embodiment of the present invention;

FIGS. 2A-C illustrate various views of a mounting device formed in accordance with a first embodiment of the present invention;

FIGS. 3A-C illustrate a mounting device formed in accordance with the second embodiment of the present invention; and

FIG. 4 shows an example mounting device with two thermal switches attached to a tube.

### DETAILED DESCRIPTION OF THE PREFERRED EMBODIMENT

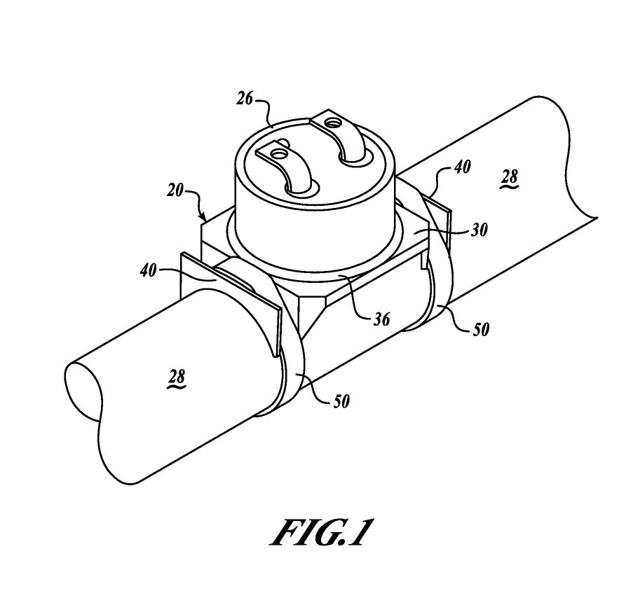

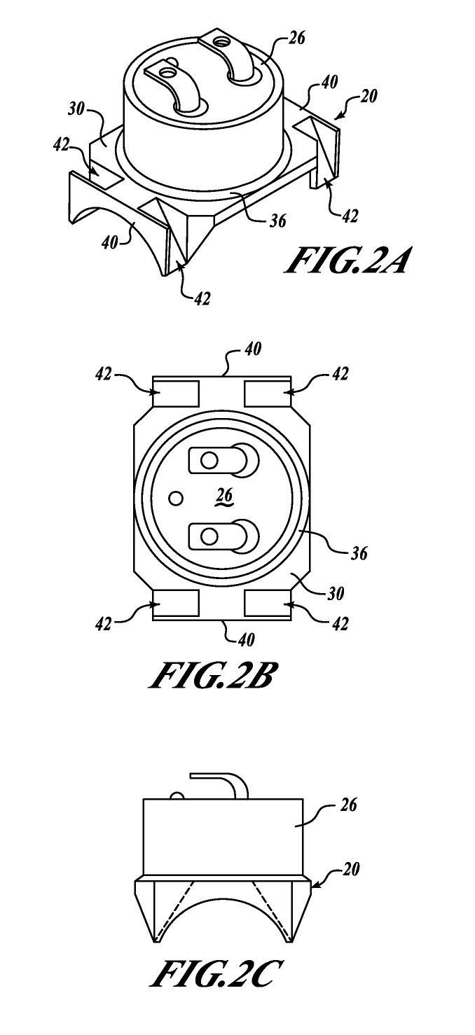

FIGS. 1, 2A-C illustrate various views of an example thermal switch attachment device 20 formed in accordance with an embodiment of the present invention. The attachment device 20 includes a base section 30 that includes a thermal switch receiving section 36 on a first side of the base section 30 and first and second flanges 40 on opposing ends of the base section 30.

Each of the flanges 40 includes a pair of opposing grooves 42 that begin at the surface of the topside of the base section 30 near a longitudinal axis of the topside and extends at an angle to respective sides of the base section 30. A second side of the base section 30 that is opposite of the first side of the base section 30 is formed to receive a tube of a particular predefined radius of curvature.

Each pair of grooves 42 at a flange 40 receives a single strap 50 that is tightened around both the flange 40 and tube 28. In one embodiment, the straps 50 are formed of a low outgassing material, such as a fluoropolymer. In another embodiment, the strap 50 is formed of stainless steel or any other material that securely holds the device 20 to the tube 28 and meets the requirements for whatever environment the device 20 will be used in. The straps 50 are held in place similar to common tie straps.

The attachment device 20 is preferably formed of aluminum or some other highly thermally conductive metal.

The thermal switch receiving section 36 is shaped to receive a thermal switch 26. The thermal switch 26 is attached within the section 36 using known materials, such as a thermally and electrically conductive, low outgassing epoxy.

In another embodiment, a thermally and electrically conductive, low outgassing epoxy is also used on the second side of the attachment device 20 for additional bonding to the tube 28.

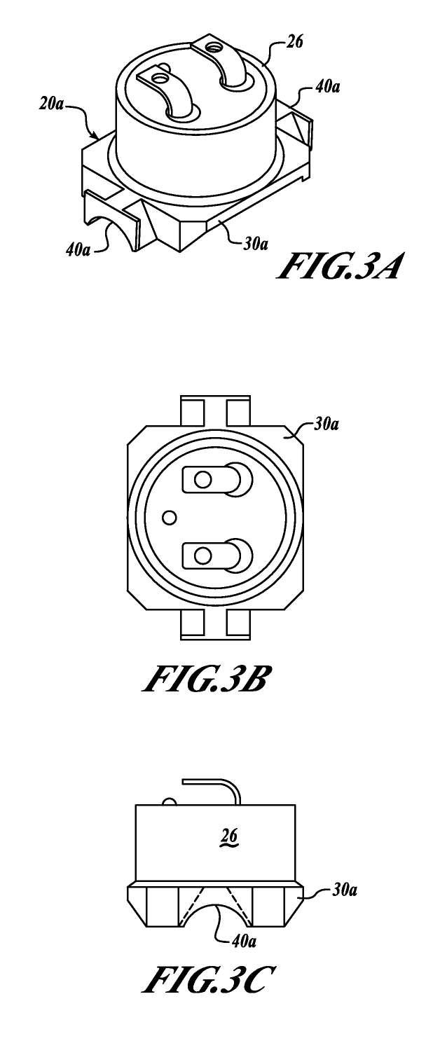

FIGS. 3A-C illustrate another attachment device 20a with flanges 40a at ends of a base section 30a having a cross-wise dimension that is smaller than a cross-wise dimension of a center portion of the device 20a. The thermal switch 26 rests on a thin aluminum (or comparable thermally conductive material) plate (not shown) when it is properly seated in the device 20a. The aluminum plate is also formed to come in contact with the attached tube thereby providing a strong thermally conductive link between the thermal switch 26 and the tube. The flanges 40a located at the ends of a base section 30a have a cross-wise dimension designed so that the tube it receives is smaller than the tubes that the device 20 can receive while all the devices 20, 20a can be configured to receive the same size thermal switch 26. Various sized thermal switches are attachable to the attachment device.

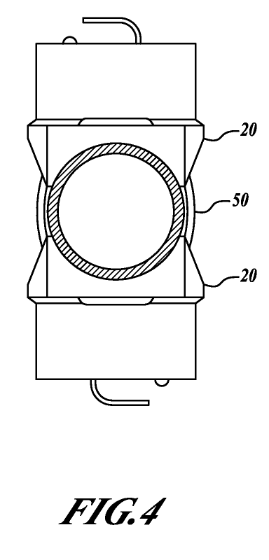

FIG. 4 illustrates two attachment devices 20 that are attached to each other on opposite sides of a tube. Two straps 50 pass through the grooves of both devices 20. The two devices 20 are shaped to attach to the same tube.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A device for attaching a thermal switch to a tube, the device comprising:
first and second ends having at least two grooves;
a thermal switch section attached to the first and second ends of the section being configured to receive a thermal switch; and
two straps configured to attach the device to a tube, the grooves receive the straps,
wherein the thermal switch section comprises a thermal section cavity and the thermal switch, the thermal switch being attached to the thermal section cavity using a thermally and electrically conductive, low outgassing epoxy.

2. The device of claim 1, wherein the first and second ends and the thermal switch section are formed of aluminum.

3. The device of claim 2, wherein the first and second ends and the thermal switch section include a low electrical resistance, chemical conversion coating.

4. The device of claim 1, wherein the straps include a low-outgassing material.

5. The device of claim 4, wherein the two straps include a fluoropolymer material.

6. The device of claim 1, wherein the device is formed to receive a tube of predefined radius on a side opposite the thermal switch section.

7. The device of claim 6, wherein the device is formed to receive a fuel line.

8. The device of claim 1, wherein the straps are further received by grooves of a second device located on an opposite side of a tube from the first device.

9. (canceled)

10. A method for attaching a thermal switch to a tube, the method comprising:
attaching a thermal switch to a thermal section cavity located between opposing ends of a base on a first side;
placing the base having a second side adjacent to the tube at the second side that is formed to receive the tube;
attaching first and second straps around the base and the tube, each strap is received by grooves located at the opposing ends of the base,
wherein attaching the thermal switch to the thermal section cavity is performed using a thermally and electrically conductive, low outgassing epoxy.

11. The method of claim 10, wherein the straps include a low outgassing material.

12. The method of claim 11, wherein the two straps include fluoropolymer material.

13. The method of claim 10, wherein the base, ends, and thermal section cavity include a low electrical resistance, chemical conversion coating.

14. The method of claim 10, wherein the straps are further received by grooves of a second device located opposite the tube from the first device.

15. (canceled)
